(19) United States
(12) Patent Application Publication
(10) Pub. No.: US 2025/0167218 A1
(43) Pub. Date: May 22, 2025

(54) POSITIVE ELECTRODE MATERIAL FOR LITHIUM SECONDARY BATTERIES AND METHOD OF MANUFACTURING THE SAME

(71) Applicants: Hyundai Motor Company, Seoul (KR); Kia Corporation, Seoul (KR); Industry Academy Cooperation Foundation of Sejong University, Seoul (KR)

(72) Inventors: Tae Ho Park, Hwaseong-si (KR); Sung Ho Ban, Hwaseong-si (KR); Sang Hun Lee, Paju-si (KR); Chang Hoon Song, Seoul (KR); Eung Ju Lee, Daejeon (KR); Ki Kang Lee, Hwaseong-si (KR); Seung Min Oh, Incheon (KR); Seung Tae Kim, Yongin-si (KR); Chang-Heum Jo, Seoul (KR); Jun Ho Yu, Seoul (KR); Hee Jae Kim, Seongnam-si (KR); ManJae Cho, Seoul (KR)

(21) Appl. No.: 18/652,112

(22) Filed: May 1, 2024

(30) Foreign Application Priority Data
Nov. 20, 2023 (KR) 10-2023-0161429

(51) Int. Cl. H01M 4/36; H01M 4/02; H01M 4/131; H01M 4/58; H01M 10/052

(52) U.S. Cl. CPC H01M 4/366; H01M 4/131; H01M 4/5825; H01M 10/052; H01M 2004/028

(57) ABSTRACT

An embodiment positive electrode material for lithium secondary batteries includes a positive electrode active material including lithium and an additive disposed at a surface of the positive electrode active material, wherein the additive includes hydroxyapatite represented by Caₐ(PO₄)_{b}(OH) (1.5≤b/a≤1.67). An embodiment method of manufacturing a positive electrode material for lithium secondary batteries includes preparing a positive electrode active material and disposing an additive including hydroxyapatite represented by Caₐ(PO₄)_{b}(OH) where (1.5≤b/a≤1.67) at a surface of the positive electrode active material.

### CROSS-REFERENCE TO RELATED APPLICATIONS

This application claims the benefit of Korean Patent Application No. 10-2023-0161429, filed on Nov. 20, 2023, which application is hereby incorporated herein by reference in its entirety.

### TECHNICAL FIELD

The present invention relates to a positive electrode material for lithium secondary batteries and a method of manufacturing the same.

### BACKGROUND

A lithium secondary battery is a battery that is capable of being charged and discharged so as to be repeatedly used. A positive electrode active material constituting a positive electrode material used in the lithium secondary battery is classified as a layered positive electrode active material or a phosphate-based positive electrode active material.

The layered positive electrode active material has been commonly used as a positive electrode material for conventional lithium secondary batteries due to better performance than the phosphate-based positive electrode active material. However, the recent increase in the raw material cost of the layered positive electrode active material, such as LiCoO₂ or LiNiₓCo_{y}Mn_{z}O₂, has highlighted the need for the phosphate-type positive electrode active material, which is relatively inexpensive.

The matters disclosed in this section are merely for enhancement of understanding of the general background of the invention and should not be taken as an acknowledgment or any form of suggestion that the matters form the related art already publicly known.

### SUMMARY

The present invention relates to a positive electrode material for lithium secondary batteries and a method of manufacturing the same. Particular embodiments relate to a positive electrode material having hydroxyapatite located at the surface thereof, wherein hydroxyapatite removes hydrofluoric acid (HF), which causes low electrical conductivity and short lifespan of a lithium secondary battery, thereby achieving high electrical conductivity and high lifespan characteristics, and a method of manufacturing the same.

Therefore, embodiments of the present invention have been made in view of problems in the art, and it is an embodiment of the present invention to provide a positive electrode material for lithium secondary batteries, wherein hydroxyapatite (Ca₅(PO₄)₃OH) located on the surface of a positive electrode active material eliminates hydrofluoric acid (HF), which causes low electrical conductivity and short lifespan of a lithium secondary battery, thereby achieving high electrical conductivity and high lifespan characteristics, and a method of manufacturing the same.

Embodiments of the present invention are not limited to the aforementioned embodiments, and other unmentioned embodiments will be clearly understood by those skilled in the art based on the following description.

In accordance with an embodiment of the present invention, the above and other embodiments can be accomplished by the provision of a positive electrode material for lithium secondary batteries, the positive electrode material including a positive electrode active material including lithium and an additive disposed at a surface of the positive electrode active material, wherein the additive includes hydroxyapatite represented by Chemical Formula 1.

Caₐ(PO₄)_{b}(OH)(1.5≤b/a≤1.67) Chemical Formula 1:

For example, the positive electrode active material may include a material represented by Chemical Formula 2.

Li(MₓFe₁₋ₓ)PO₄(0.1≤x≤0.9) Chemical Formula 2:

In Chemical Formula 2, M is at least one element selected from a transition metal group including manganese (Mn).

For example, the weight of the additive may be 1 to 3 wt % based on 100 wt % of the total positive electrode material.

For example, hydroxyapatite may have a peak at about 32 to 33 degrees when analyzing an X-ray diffraction angle (2θ) using a Cu Kα ray.

For example, the positive electrode active material and hydroxyapatite maybe physically mixed with each other in a powder state such that hydroxyapatite is located at the surface of the positive electrode active material.

For example, the positive electrode active material and hydroxyapatite maybe milled at 100 to 300 rpm in a powder state such that hydroxyapatite is located at the surface of the positive electrode active material.

For example, the positive electrode active material and hydroxyapatite maybe milled for 20 to 40 minutes in a powder state such that hydroxyapatite is located at the surface of the positive electrode active material.

For example, the additive may be a particle having a particle size of 3 μm or less (except for 0 μm).

In another embodiment of the present invention, there is provided a method of manufacturing a positive electrode material for lithium secondary batteries, the method including preparing a positive electrode active material and disposing an additive including hydroxyapatite represented by Chemical Formula 1 at a surface of the positive electrode active material.

Caₐ(PO₄)_{b}(OH)(1.5≤b/a≤1.67) Chemical Formula 1:

For example, the positive electrode active material may include a material represented by Chemical Formula 2.

Li(MₓFe₁₋ₓ)PO₄(0.1≤x≤0.9) Chemical Formula 2:

In Chemical Formula 2, M is at least one element selected from a transition metal group including manganese (Mn).

For example, in the step of disposing the additive at the surface of the positive electrode active material, the weight of the additive may be 1 to 3 wt % based on 100 wt % of the total positive electrode material.

For example, the step of disposing the additive at the surface of the positive electrode active material may include physically mixing the positive electrode active material and hydroxyapatite with each other in a powder state.

For example, the positive electrode active material and hydroxyapatite maybe physically mixed with each other by milling at 100 to 300 rpm.

For example, the positive electrode active material and hydroxyapatite maybe physically mixed with each other by milling for 20 to 40 minutes.

For example, the additive may be a particle having a particle size of 3 μm or less (except for 0 μm).

### BRIEF DESCRIPTION OF THE DRAWINGS

The above and other objects, features, and other advantages of embodiments of the present invention will be more clearly understood from the following detailed description taken in conjunction with the accompanying drawings, in which:

FIG. 1 is a view showing a reaction of hydroxyapatite with hydrofluoric acid (HF), resulting in phase transition to fluoride;

FIG. 2 is a view showing EELS images of the surface of a positive electrode material for lithium secondary batteries according to an embodiment of the present invention;

FIG. 3 is a view showing an analytical image of the X-ray diffraction angle (2θ) of hydroxyapatite using a Cu Kα ray;

FIG. 4 is a view showing an analytical image of the X-ray diffraction angle (2θ) of the positive electrode material for lithium secondary batteries according to an embodiment of the present invention using a Cu Kα ray;

FIG. 5 is a view showing a method of manufacturing a positive electrode material for lithium secondary batteries according to an embodiment of the present invention;

FIG. 6 is a graph showing initial charge capacities, initial discharge capacities, and initial Coulombic efficiencies (ICE) of batteries according to examples and a comparative example for comparison;

FIG. 7 is a graph showing C-rate based capacity characteristics of the batteries according to the examples and the comparative example for comparison;

FIG. 8 is a graph showing room-temperature lifespan characteristics of the batteries according to the examples and the comparative example for comparison;

FIG. 9 is a graph showing high-temperature lifespan characteristics of the batteries according to the examples and the comparative example for comparison; and

FIG. 10 is a graph showing high-rate lifespan characteristics of the batteries according to the examples and the comparative example for comparison.

### DETAILED DESCRIPTION OF ILLUSTRATIVE EMBODIMENTS

The present invention may be variously modified and may have various embodiments, and therefore specific embodiments will be shown in the drawings and will be described in detail. However, the embodiments according to the concept of the present invention are not limited to such specific embodiments, and it should be understood that the present invention includes all alterations, equivalents, and substitutes that fall within the idea and technical scope of the present invention.

The terms used in this specification are provided only to explain specific embodiments, but they are not intended to restrict the present invention. A singular representation may include a plural representation unless it represents a definitely different meaning from the context. It will be further understood that the terms “comprises,” “has,” and the like, when used in this specification, specify the presence of stated features, numbers, steps, operations, elements, components, or combinations thereof, but do not preclude the presence or addition of one or more other features, numbers, steps, operations, elements, components, or combinations thereof.

When a range of “X to Y” is described in this specification, it should be construed to include all numbers between X and Y. As an example, when a range of 1 to 10 is described, it should be interpreted as including not only 1 and 10 but also all numbers in between, i.e., integers and decimals.

Unless otherwise defined, all terms, including technical and scientific terms, used in this specification have the same meanings as those commonly understood by a person having ordinary skill in the art to which the present invention pertains. It will be further understood that terms, such as those defined in commonly used dictionaries, should be interpreted as having meanings consistent with their meanings in the context of the relevant art and the present disclosure, and they are not to be interpreted in an idealized or overly formal sense unless expressly so defined herein.

In a positive electrode material for lithium secondary batteries according to embodiments of the present invention and a method of manufacturing the same, hydroxyapatite located at the surface of a positive electrode active material removes hydrofluoric acid (HF), which causes low electrical conductivity and short lifespan of a lithium secondary battery, thereby achieving high electrical conductivity and high lifespan characteristics of the lithium secondary battery.

In order to describe the positive electrode material for lithium secondary batteries according to embodiments of the present invention, a positive electrode, a negative electrode, an electrolyte, and a separator of a lithium secondary battery will be described. In addition, the positive electrode material for lithium secondary batteries according to embodiments of the present invention will be described based on a lithium secondary battery using the positive electrode material for lithium secondary batteries according to embodiments of the present invention.

### Positive Electrode

The positive electrode material for lithium secondary batteries according to embodiments of the present invention includes a positive electrode active material and an additive disposed at the surface of the positive electrode active material.

The positive electrode active material may be LiFePO₄ or a compound represented by Chemical Formula 2 below.

Li(MₓFe₁₋ₓ)PO₄(0.1≤x≤0.9) Chemical Formula 2:

In Chemical Formula 2, transition metal (M) used to substitute a part of iron (Fe) may be at least one element selected from a transition metal group including Sc, Ti, V, Cr, Fe, Co, Ni, Cu, Zn, Y, Zr, Nb, Mo, Tc, Ru, Rh, Pd, Ag, Cd, Lu, Hf, Ta, W, Re, Os, Ir, Pt, Au, Hg, Lr, Rf, Db, Sg, Bh, Hs, Mt, Ds, Rg, Cn, and Mn.

For example, Li(MnₓFe₁₋ₓ)PO₄ (0.1≤x≤0.9), which has an olivine structure in which a part of Fe in LiFePO₄ is replaced by Mn, may be used.

In this case, a part of Fe³⁺/Fe²⁺ redox reaction at 3.4 V may be replaced by Mn³⁺/Mn²⁺ redox reaction at 4.1 V, which may increase operating voltage and energy density of the lithium secondary battery.

If the operating voltage is increased, however, electrolyte side reactions may easily occur due to the increased operating voltage. The electrolyte side reaction may produce hydrofluoric acid (HF). Hydrofluoric acid (HF) may react with lithium hydroxide to form lithium fluoride (LiF), as represented by Chemical Formula 3 below, and lithium fluoride (LiF) may be deposited on the electrode of the lithium secondary battery to form a solid electrolyte interphase (SEI).

LiOH+HF→LiF(precipitated)+H₂O Chemical Formula 3:

The SEI is a thin solid film formed at the positive electrode or the negative electrode as the result of a chemical side reaction between lithium ions and an additive in an electrolytic solution when the lithium ions move from the positive electrode to the negative electrode during charging of the lithium secondary battery. The SEI thus formed has very high electrical resistance. The solid electrolyte interphase (SEI) formed at the surface of the electrode may interfere with redox reaction of the electrode of the lithium secondary battery and may cause degradation, low electrical conductivity, and short lifespan of the lithium secondary battery.

If hydrofluoric acid can be removed, therefore, formation of the SEI may be prevented, and problems with the lithium secondary battery, such as degradation, low electrical conductivity, and short lifespan, may be effectively alleviated.

In order to remove hydrofluoric acid (HF) from the lithium secondary battery, the positive electrode material for lithium secondary batteries according to embodiments of the present invention includes a positive electrode active material and an additive disposed at the surface of the positive electrode active material, wherein the additive includes hydroxyapatite represented by Chemical Formula 1.

Caₐ(PO₄)_{b}(OH)(1.5≤b/a≤1.67) Chemical Formula 1:

Hydroxyapatite is a chemically and structurally stable material including calcium and phosphorus and has excellent thermal stability. Hydroxyapatite may be stably present in the lithium secondary battery, even when exposed to high temperatures and extreme environments, due to such properties thereof.

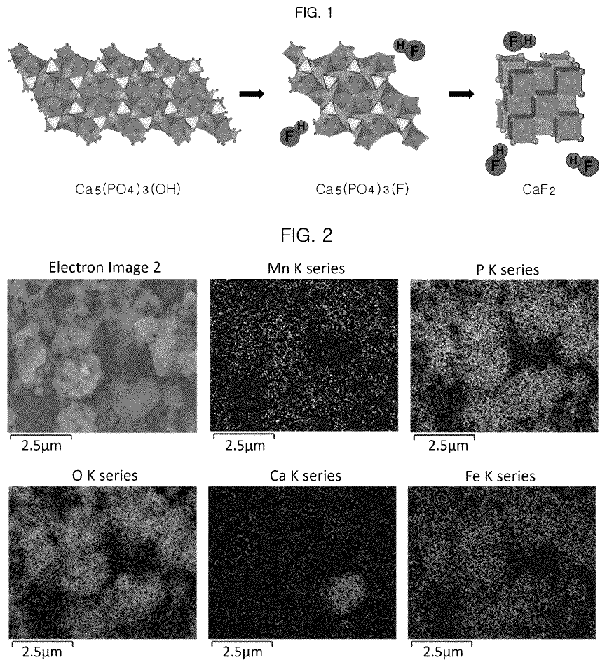

FIG. 1 shows reaction of hydroxyapatite with hydrofluoric acid (HF), resulting in phase transition to fluoride. The positive electrode material for lithium secondary batteries according to embodiments of the present invention will continue to be described with reference to FIG. 1.

Hydroxyapatite undergoes several reaction steps with hydrofluoric acid in the lithium secondary battery, resulting in phase transition to fluoride. This process may remove hydrofluoric acid from the lithium secondary battery. Detailed reaction equations of several reaction steps are shown in Chemical Formula 4 below.

Ca₅(PO₄)₃OH+HF→Ca₅(PO₄)₃F+H₂O(reaction of hydroxyapatite with hydrofluoric acid as electrolyte degradation product)

Ca₅(PO₄)₃F+9HF→5CaF₂+3H₃PO₄(formation of final product CaF₂)

Ca₅(PO₄)₃OH+10HF→5CaF₂+3H₃PO₄(result of final reaction) Chemical Formula 4:

Hydroxyapatite may effectively remove hydrofluoric acid from the lithium secondary battery through the processes. As a result, the formation of the SEI may be inhibited, and problems with the lithium secondary battery during charging and discharging, such as low electrical conductivity and short lifespan, may be effectively solved. In addition, since hydroxyapatite is a chemically and structurally stable material with excellent thermal stability, hydroxyapatite may be stably present during continuous use of the lithium secondary battery to remove hydrofluoric acid.

FIG. 2 is a view showing EELS images of the surface of a positive electrode material for lithium secondary batteries according to an embodiment of the present invention. The surface structure of the positive electrode material for lithium secondary batteries according to embodiments of the present invention will be described with reference to FIG. 2.

Referring to the EELS images of FIG. 2, the additive including hydroxyapatite of embodiments of the present invention may be located at the surface of the positive electrode active material and may be predominantly located in pores.

Since hydroxyapatite is exposed at the surface of the positive electrode active material, as described above, hydroxyapatite may effectively react with hydrofluoric acid present in the electrolyte of the lithium secondary battery, thereby effectively preventing the formation of the SEI at the surface of the positive electrode active material.

The positive electrode active material and hydroxyapatite may be physically mixed in a powder state such that hydroxyapatite is located at the surface of the positive electrode active material. In order to locate hydroxyapatite at the surface of the positive electrode active material, hydroxyapatite may be physically mixed with the positive electrode active material. One physical mixing method may be mixing by low-intensity milling.

Hydroxyapatite located at the surface of the positive electrode active material may be located on the surface of the positive electrode active material so as to be formed as a layered structure and may be disposed in an island shape. Here, the island shape may be a discontinuous arrangement of hemispherical, non-spherical, or amorphous shapes each having a predetermined volume.

In addition, the content of the additive may be 1 to 5 wt %, preferably 1 to 3 wt %, based on 100 wt % of the total positive electrode material.

If the weight of the additive including hydroxyapatite is too large, the weight of the positive electrode active material per unit mass of the positive electrode material for lithium secondary batteries may be reduced, and the amount of active lithium per unit volume of the electrode may be reduced, resulting in a decrease in the capacity of the lithium secondary battery including the same.

If the weight of the additive including hydroxyapatite is too small, on the other hand, the effectiveness of the additive that removes hydrofluoric acid may be insignificant. Therefore, hydroxyapatite may satisfy a given weight range.

In addition, the additive including hydroxyapatite may be a particle having a particle size of 3 μm or less (except for 0 μm).

When the particle size of the additive is 3 μm or less, the additive may be effectively located at the surface of the positive electrode active material and may be easily located in the pores.

Therefore, the above range may be satisfied.

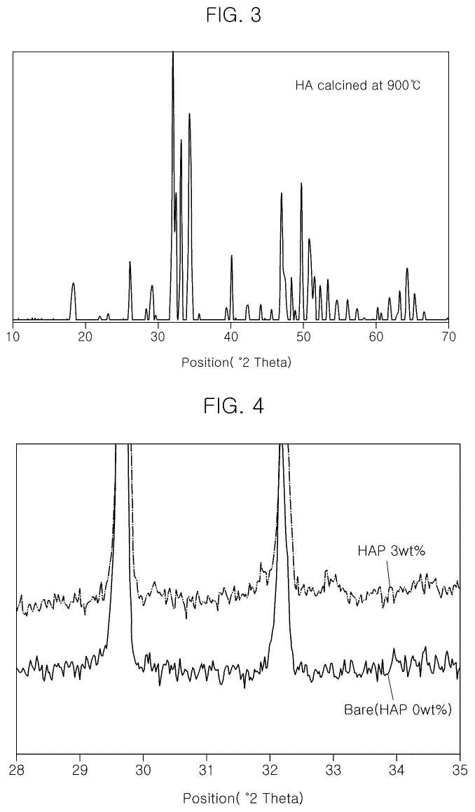

FIG. 3 shows an analytical image of the X-ray diffraction angle 26 of hydroxyapatite using a Cu Kα ray, and FIG. 4 shows an analytical image of the X-ray diffraction angle 26 of the positive electrode material for lithium secondary batteries according to embodiments of the present invention using a Cu Kα ray.

The analysis result of the X-ray diffraction angle 26 of the positive electrode active material of embodiments of the present invention using the Cu Kα ray will be described with reference to FIGS. 3 and 4.

According to FIG. 3, hydroxyapatite has a peak at about 32 to 33 degrees when analyzing the X-ray diffraction angle 26 using the Cu Kα ray.

According to FIG. 4, the positive electrode material (Bare, HAP 0 wt %) for lithium secondary batteries having no hydroxyapatite added thereto does not have a peak at about 32 to 33 degrees when analyzing the X-ray diffraction angle 26 using the Cu Kα ray. However, the positive electrode material (HAP 3 wt %) for lithium secondary batteries according to embodiments of the present invention has a peak at about 32 to 33 degrees when analyzing the X-ray diffraction angle 26 using the Cu Kα ray, which can be seen to be caused by the additive including hydroxyapatite located at the surface of the positive electrode active material of embodiments of the present invention.

From the experimental results, it can be seen that the additive including hydroxyapatite is located at the surface of the positive electrode material for lithium secondary batteries according to embodiments of the present invention.

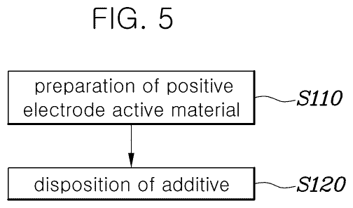

FIG. 5 is a view showing a method of manufacturing a positive electrode material for lithium secondary batteries according to an embodiment of the present invention. The method of manufacturing the positive electrode material for lithium secondary batteries according to embodiments of the present invention will be described with reference to FIG. 5.

First, a step of preparing a positive electrode active material may be performed (S110).

Mn nitrate, Fe nitrate, citric acid, sucrose, and an ammonia solution may be prepared as raw materials to be synthesized. LiH₂PO₄, as a metal raw material, a transition metal raw material, and citric acid and sucrose may be added to deionized water in a molar ratio of 1:0.2:0.1 and stirred.

At this time, the ammonia solution may be added to the solution to adjust pH of the solution to 2.

The solution may be stirred at 1000 rpm and 95° C. (lab stirrer indicator: 250° C.) to produce a sol.

Subsequently, the sol may be dried until a viscous gel is formed, and the gel may be introduced into a box furnace heated to 200° C. so as to be completely dried.

Subsequently, a container containing dried powder may be tapped to collect the powder, and the furnace may be heated to 400° C. for pretreatment.

Subsequently, the pretreated powder, pitch carbon, and a conductive agent (Denka black) may be added to ethanol and may be milled at 300 rpm for one hour. The milled powder may be dried in a convection oven at 200° C.

Subsequently, the dried powder may be heat-treated in an argon/hydrogen 4% environment at 680° C. for 10 hours, ethanol may be added to the heat-treated powder, and the powder may be ground by milling at 300 rpm for one hour.

Next, a step of locating an additive including hydroxyapatite at the surface of the positive electrode active material may be performed (S120).

The hydroxyapatite powder may be dried under vacuum at 120° C. for 24 hours before use.

At this time, the hydroxyapatite powder may be quantified such that the content of the additive is 1 to 5 wt %, preferably 1 to 3 wt %, based on 100 wt % of the total positive electrode material.

The hydroxyapatite powder may be added to the positive electrode active material powder manufactured through the step of preparing the positive electrode active material (S110), and the hydroxyapatite powder and the positive electrode active material powder may be physically mixed with each other such that the additive is disposed at the surface of the positive electrode active material.

At this time, the hydroxyapatite powder and the positive electrode active material powder may be physically mixed with each other by milling, which may be performed at a speed of 100 to 200 RPM for 20 to 40 minutes. Preferably, mixing is performed at a speed of 150 RPM for 30 minutes.

Subsequently, the mixture may be dried under vacuum at 120° C. for 12 hours.

The method is merely illustrative, and the present invention is not limited thereto.

The positive electrode active material having hydroxyapatite located at the surface of the positive electrode active material may be obtained through the above method.

The positive electrode active material, a conductive agent, and a binder may be mixed with each other to obtain a positive electrode material. Here, the conductive agent may be a carbon material such as natural graphite, synthetic graphite, coke, carbon black, carbon nanotubes, or graphene. The binder may include a thermoplastic resin, for example, a fluoroplastic resin such as polyvinylidene fluoride, polytetrafluoroethylene, ethylene tetrafluoride, a vinylidene fluoride copolymer, or hexafluoropropylene, and/or a polyolefin resin such as polyethylene or polypropylene.

The positive electrode material may be applied to a positive electrode current collector to form a positive electrode. The positive electrode current collector may be a conductor such as Al, Ni, or stainless steel. The positive electrode material may be applied to the positive electrode current collector by pressure molding or using a method of forming a paste using an organic solvent, applying the paste to the current collector, and pressing the paste to solidify the paste. The organic solvent may be an amine-based solvent such as N,N-dimethylaminopropylamine or diethylenetriamine, an ether-based solvent such as ethylene oxide or tetrahydrofuran, a ketone-based solvent such as methyl ethyl ketone, an ester-based solvent such as methyl acetate, or a polar aprotic solvent such as dimethylacetamide or N-methyl-2-pyrrolidone. The paste may be applied to the positive electrode current collector by, for example, gravure coating, slit die coating, knife coating, or spray coating.

### Negative Electrode

A negative electrode active material may be formed using a metal capable of causing intercalation and deintercalation or conversion of lithium ions, a metal alloy, a metal oxide, a metal fluoride, a metal sulfide, or a carbon material such as natural graphite, synthetic graphite, coke, carbon black, carbon nanotubes, or graphene.

The negative electrode active material, a conductive agent, and a binder may be mixed with each other to obtain a negative electrode material. Here, the conductive agent may be a carbon material such as natural graphite, synthetic graphite, coke, carbon black, carbon nanotubes, or graphene. The binder may include a thermoplastic resin, for example, a fluoroplastic resin such as polyvinylidene fluoride, polytetrafluoroethylene, ethylene tetrafluoride, a vinylidene fluoride copolymer, or hexafluoropropylene, and/or a polyolefin resin such as polyethylene or polypropylene.

The negative electrode material may be applied to a negative electrode current collector to form a negative electrode. The negative electrode current collector may be a conductor such as Al, Ni, or stainless steel. The negative electrode material may be applied to the negative electrode current collector by pressure molding or using a method of forming a paste using an organic solvent, applying the paste to the current collector, and pressing the paste to solidify the paste. The organic solvent may be an amine-based solvent such as N,N-dimethylaminopropylamine or diethylenetriamine, an ether-based solvent such as ethylene oxide or tetrahydrofuran, a ketone-based solvent such as methyl ethyl ketone, an ester-based solvent such as methyl acetate, or a polar aprotic solvent such as dimethylacetamide or N-methyl-2-pyrrolidone. The paste may be applied to the negative electrode current collector by, for example, gravure coating, slit die coating, knife coating, or spray coating.

### Electrolyte

The electrolyte may be a lithium salt. The lithium salt may be lithium perchlorate (LiClO₄), lithium tetrafluoroborate (LiBF₄), lithium hexafluorophosphate (LiPF₆), lithium trifluoromethanesulfonate (LiCF₃SO₃), lithium hexafluoroacetate (LiAsF₆), lithium trifluoromethanesulfonyl imide (Li(CF₃SO₂)₂N), or a mixture of two or more thereof. Thereamong, an electrolyte including fluorine may be used. In addition, the electrolyte may be dissolved in an organic solvent so as to be used as a non-aqueous electrolytic solution.

As the organic solvent, for example, there may be used carbonate such as propylene carbonate, ethylene carbonate, dimethyl carbonate, diethyl carbonate, ethylmethyl carbonate, isopropylmethyl carbonate, vinylene carbonate, 4-trifluoromethyl-1,3-dioxolan-2-one, or 1,2-di(methoxycarbonyloxy)ethane, ether such as 1,2-dimethoxyethane, 1,3-dimethoxypropane, pentafluoropropylmethyl ether, 2,2,3,3-tetrafluoropropyldifluoromethyl ether, tetrahydrofuran, or 2-methyltetrahydrofuran, ester such as methyl formate, methyl acetate, or γ-butyrolactone, nitrile such as acetonitrile or butyronitrile, amide such as N,N-dimethylformamide or N,N-dimethylacetamide, carbamate, such as 3-methyl-2-oxazolidone, a sulfur-containing compound such as sulfolane, dimethylsulfoxide, or 1,3-propanesulfonate, or any of the above organic solvents with an additional fluorine substituent introduced. Alternatively, a solid electrolyte may be used. The solid electrolyte may be an organic-based solid electrolyte, such as a polyethylene oxide-based polymeric compound or a polymeric compound including at least one of a polyorganosiloxane chain and a polyoxyalkylene chain. In addition, a so-called gel-type electrolyte, in which a polymeric compound is impregnated with a non-aqueous electrolytic solution, may be used. Alternatively, an inorganic solid electrolyte may be used. Safety of a sodium secondary battery may be further increased using the solid electrolyte. In addition, the solid electrolyte may function as a separator, a description of which will follow. In this case, no separator may be required.

### Separator

The separator may be disposed between the positive electrode and the negative electrode. The separator may be a material having the form of a porous film, a nonwoven fabric, or a woven fabric made of a polyolefin resin such as polyethylene or polypropylene, a fluorinated resin, or a nitrogen-containing aromatic polymer. It is preferable for the thickness of the separator to be smaller as long as the mechanical strength of the separator is maintained in that the volumetric energy density of the battery is increased and internal resistance of the battery is decreased. The thickness of the separator may generally be 5 to 200 μm and more specifically 5 to 40 μm.

Hereinafter, a method of manufacturing an experimental example of a secondary battery for implementing an embodiment of the present invention will be described. The method is merely illustrative, and the present invention is not limited thereto.

### Method of Manufacturing Lithium Secondary Battery

A secondary battery may be manufactured by stacking a positive electrode, a separator, and a negative electrode in that order to form an electrode group, receiving the electrode group in a battery can in a state of being rolled if necessary, and impregnating the electrode group with a non-aqueous electrolyte solution. Alternatively, a secondary battery may be manufactured by stacking a positive electrode, a solid electrolyte, and a negative electrode to form an electrode group and receiving the electrode group in a battery can in a state of being rolled if necessary.

### Electrode Manufacturing Example

10 g of NMP including 2% PVDF and 4.8 g of the positive electrode material for lithium secondary batteries according to embodiments of the present invention (active material:conductive agent:binder=90:6:4) are stirred at 2000 rpm for 20 minutes three times to manufacture a slurry.

The slurry is applied to aluminum foil and is cast using a doctor blade. At this time, the thickness of the slurry is 150 μm except for the foil.

Subsequently, the slurry is dried in a convection oven at 120° C., is sequentially pressed to 30 μm using a press having a pressure of 2 tons, and is dried in a vacuum oven at 100° C. for one day.

### Battery Manufacturing Example

An electrolyte (1M LiPF₆ in EC:DEC 7:3), a lithium metal, and a separator (alumina coated PP) are prepared, and the positive electrode manufactured according to the electrode manufacturing example is prepared.

First, the positive electrode is placed on the bottom of a battery. 20 μL of the electrolyte is introduced, and the separator is placed thereon. The separator is fixed using a gasket, and 80 μL of the electrolyte is introduced. A current collector having the lithium metal attached thereto is placed thereon, a spring is placed thereon, a cap is mounted, and a battery is fastened.

Subsequently, the manufactured battery is stored at room temperature for a quarter of a day to stabilize the battery, which is called a coin cell stabilization process.

### EXAMPLES

### Example 1

A coin cell is manufactured using a positive electrode material for lithium secondary batteries according to embodiments of the present invention manufactured by quantifying hydroxyapatite so as to account for 1 wt % based on 100 wt % of the total positive electrode material.

### Example 2

A coin cell is manufactured using a positive electrode material for lithium secondary batteries according to embodiments of the present invention manufactured by quantifying hydroxyapatite so as to account for 3 wt % based on 100 wt % of the total positive electrode material.

### Example 3

A coin cell is manufactured using a positive electrode material for lithium secondary batteries according to embodiments of the present invention manufactured by quantifying hydroxyapatite so as to account for 5 wt % based on 100 wt % of the total positive electrode material.

### COMPARATIVE EXAMPLE

### Comparative Example 1

A coin cell is manufactured using a positive electrode material for lithium secondary batteries having no hydroxyapatite added thereto (Bare, HAP 0 wt %).

The following is experimental data of the batteries according to the examples and the comparative example for comparison.

Capacity retention is defined as the charge capacity measured after a specific number of charge and discharge cycles divided by the initial charge capacity.

### Initial Capacity/Initial Coulombic Efficiency (ICE)

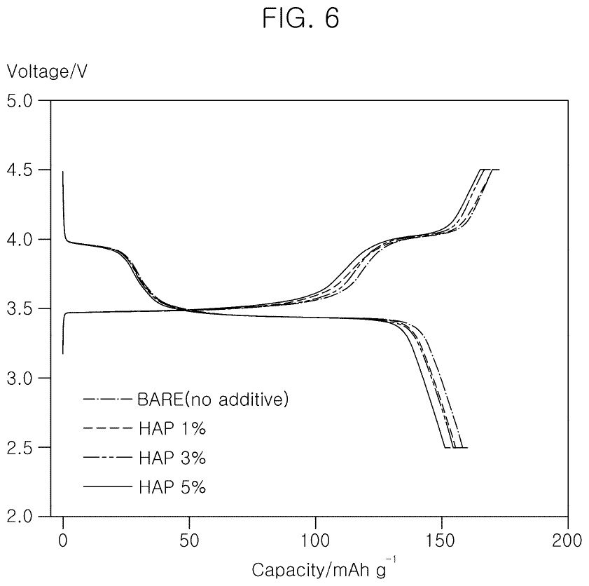

FIG. 6 is a graph showing initial charge capacities, initial discharge capacities, and initial Coulombic efficiencies (ICE) of the batteries according to the examples and the comparative example for comparison.

The initial discharge capacity and the voltage of each battery at the time of initial discharge were measured, which is shown as a charge and discharge curve. Experimental conditions include a C-rate of 0.1 C and a temperature of 25° C.

Referring to FIG. 6, the difference in initial Coulombic efficiency (ICE) between the batteries according to the examples and the battery according to the comparative example was not significant.

It can be seen therefrom that the positive electrode material for lithium secondary batteries according to embodiments of the present invention has excellent initial capacity and initial Coulombic efficiency (ICE) when the weight of the additive is 1 to 5 wt % based on 100 wt % of the total positive electrode material.

TABLE 1

| | Initial charge | Initial discharge | |
|---|---|---|---|
| | capacity | capacity | ICE |
| BARE (Comparative | 171.79 mAh/g | 159.92 mAh/g | 93.09% |
| Example 1) | | | |
| HAP 1% (Example 1) | 172.28 mAh/g | 157.38 mAh/g | 91.34% |
| HAP 3% (Example 2) | 168.58 mAh/g | 156.36 mAh/g | 92.74% |
| HAP 5% (Example 3) | 167.34 mAh/g | 153.08 mAh/g | 91.47% |

Table 1 shows initial charge capacities, initial discharge capacities, and initial Coulombic efficiencies (ICE) of the batteries according to the examples and the comparative example.

The initial Coulombic efficiency (ICE) was calculated using Mathematical Expression 1 below.

$$Initial Coulombic efficiency ( I C E ) = [ initial charge capacity / \\ initial discharge capacity ] \times 100 ( \% ) \qquad Mathematical Expression 1$$

### Rate Characteristics (0.1 to 2 C, 25° C.)

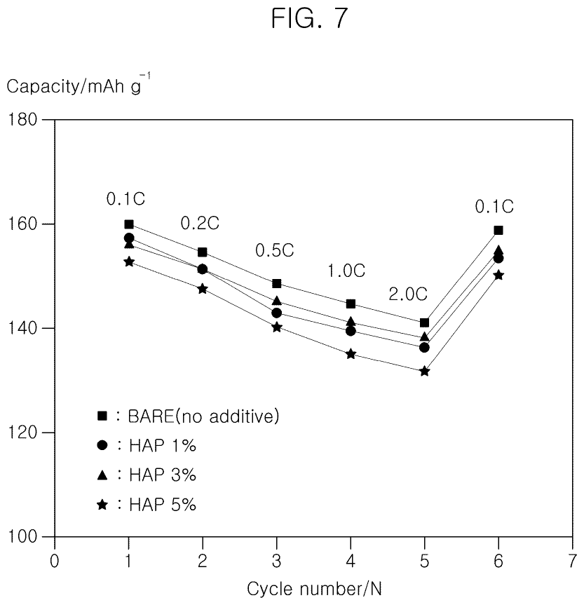

FIG. 7 is a graph showing C-rate based capacity characteristics of the batteries according to Examples 1, 2, and 3 and Comparative Example 1 for comparison.

The capacity of each battery over charge and discharge cycles was measured, and experimental conditions include a C-rate of 0.1 C to 2.0 C and a temperature of 25° C.

Referring to FIG. 7 and Table 2, the batteries according to the examples exhibit similar capacity retention over charge and discharge cycles to that of the battery according to the comparative example.

It can be seen therefrom that the positive electrode material for lithium secondary batteries according to embodiments of the present invention has excellent capacity retention when the weight of the additive is 1 to 5 wt % based on 100 wt % of the total positive electrode material.

TABLE 2

| | | | | | | 0.1 C |
|---|---|---|---|---|---|---|
| | 0.1 C | 0.2 C | 0.5 C | 1.0 C | 2.0 C | (Recovery) |
| BARE | 159.92 mAh/g | 154.65 mAh/g | 148.64 mAh/g | 144.72 mAh/g | 141.13 mAh/g | 158.85 mAh/g |
| (Comparative | | | | | | |
| Example 1) | | | | | | |
| HAP 1% | 157.38 mAh/g | 151.40 mAh/g | 142.99 mAh/g | 139.61 mAh/g | 136.36 mAh/g | 153.56 mAh/g |
| (Example 1) | | | | | | |
| HAP 3% | 156.36 mAh/g | 151.38 mAh/g | 145.05 mAh/g | 141.21 mAh/g | 138.21 mAh/g | 154.96 mAh/g |
| (Example 2) | | | | | | |
| HAP 5% | 153.08 mAh/g | 147.87 mAh/g | 140.52 mAh/g | 135.35 mAh/g | 131.85 mAh/g | 150.25 mAh/g |
| (Example 3) | | | | | | |

Table 2 shows C-rate based capacities of the batteries according to the examples and the comparative example.

0.1 C (Recovery) represents the charge capacity of the battery when the battery is recharged to 0.1 C after discharge.

### Room-Temperature Lifespan Characteristics (0.5 C, 25° C.)

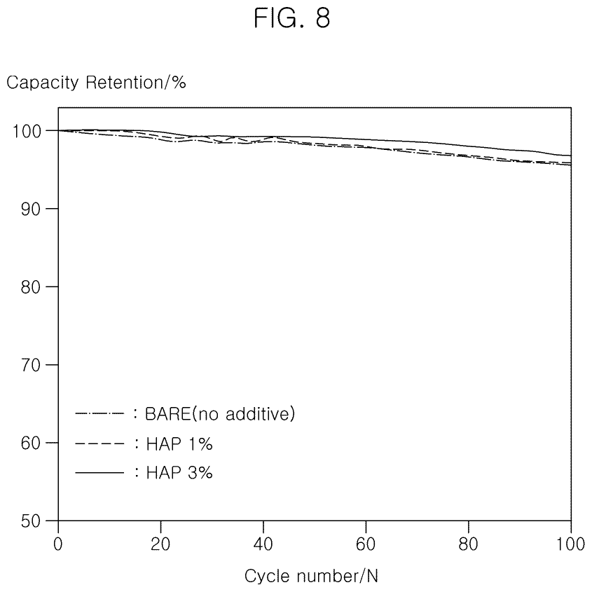

FIG. 8 is a graph showing room-temperature capacity characteristics of the batteries according to Examples 1 and 2 and Comparative Example 1 for comparison.

The capacity of each battery over charge and discharge cycles at room temperature was measured. At this time, constant current charging was performed at room temperature (25° C.) with a current of 0.5 C until the voltage reached 0.01 V (vs. Li+/Li), and constant voltage charging was performed in a cut-off state at a current at 0.01 C while maintaining 0.01 V (vs. Li+/Li) in a constant voltage mode. Discharging at a constant current of 0.5 C was repeated 100 times until the voltage reached 1.5 V (vs. Li+/Li).

Referring to FIG. 8, the batteries according to the examples exhibit similar capacity retention over charge and discharge cycles to that of the battery according to the comparative example.

It can be seen therefrom that the positive electrode material for lithium secondary batteries according to embodiments of the present invention has excellent room-temperature (25° C.) capacity retention when the weight of the additive is 1 to 5 wt % based on 100 wt % of the total positive electrode material.

TABLE 3

| | Capacity Retention |
|---|---|
| BARE 0% (Comparative Example 1) | 96.1% |
| HAP 1% (Example 1) | 96.1% |
| HAP 3% (Example 2) | 96.6% |

Table 3 shows capacity retention of each of the batteries according to the examples and the comparative example after 100 charge and discharge cycles.

The capacity retention was calculated using Mathematical Expression 2 below.

$$Capacity retention = [ Discharge capacity at 100 th cycle / \\ discharge capacity at first cycle ] \times 100 ( \% ) \qquad Mathematical Expression 2$$

### High-Temperature Lifespan Characteristics (0.5 C)

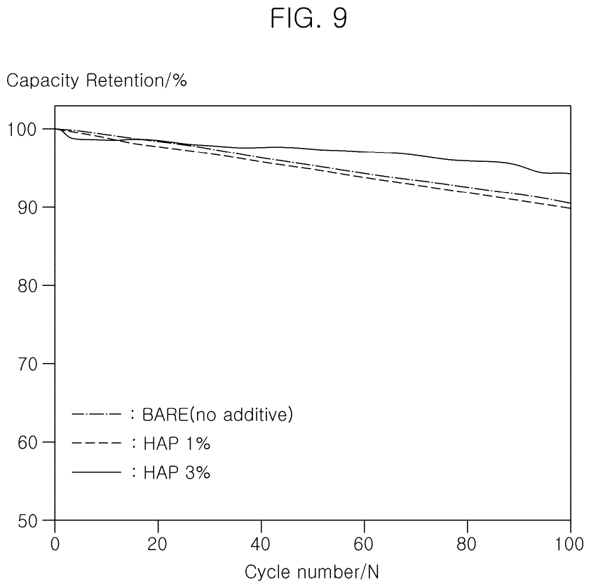

FIG. 9 is a graph showing high-temperature (45° C.) capacity characteristics of the batteries according to Examples 1 and 2 and Comparative Example 1 for comparison.

The capacity of each battery over charge and discharge cycles at high temperature was measured. At this time, constant current charging was performed at high temperature (45° C.) with a current of 0.5 C until the voltage reached 0.01 V (vs. Li+/Li), and constant voltage charging was performed in a cut-off state at a current at 0.01 C while maintaining 0.01 V (vs. Li+/Li) in a constant voltage mode. Discharging at a constant current of 0.5 C was repeated 100 times until the voltage reached 1.5 V (vs. Li+/Li).

Referring to FIG. 9, the batteries according to the examples exhibit higher capacity retention over charge and discharge cycles than the battery according to the comparative example.

It can be seen therefrom that the positive electrode material for lithium secondary batteries according to embodiments of the present invention has excellent high-temperature (45° C.) capacity retention when the weight of the additive is 1 to 3 wt % based on 100 wt % of the total positive electrode material.

It can be seen that hydroxyapatite improves high-temperature lifespan characteristics of the lithium secondary battery.

TABLE 4

| | Capacity Retention |
|---|---|
| BARE 0% (Comparative Example 1) | 90.2% |
| HAP 1% (Example 1) | 89.9% |
| HAP 3% (Example 2) | 94.0% |

Table 4 shows capacity retention of each of the batteries according to the examples and the comparative example after 100 charge and discharge cycles.

The capacity retention was calculated using Mathematical Expression 3 below.

$$Capacity retention = [ Discharge capacity at 100 th cycle / \\ discharge capacity at first cycle ] \times 100 ( \% ) \qquad Mathematical Expression 3$$

### High-Rate Lifespan Characteristics (2.0 C, 25° C.)

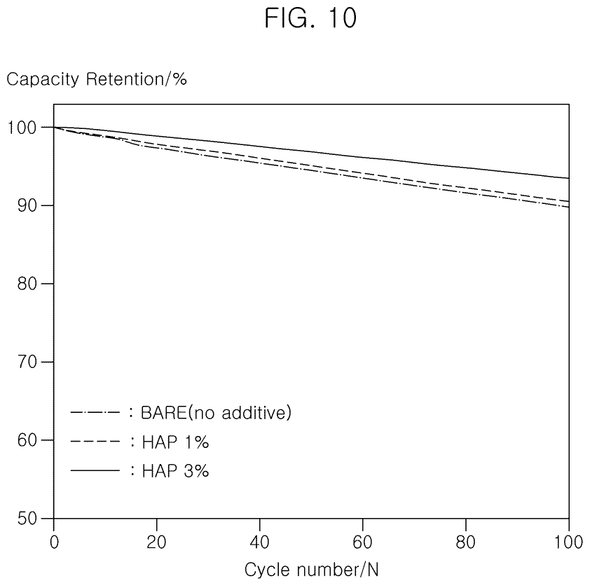

FIG. 10 is a graph showing high-rate lifespan characteristics of the batteries according to the examples and the comparative example for comparison.

The capacity of each battery over charge and discharge cycles at high rate was measured, and experimental conditions include a C-rate of 2.0 C and a temperature of 25° C.

Referring to FIG. 10, the batteries according to the examples exhibit higher capacity retention over charge and discharge cycles than the battery according to the comparative example.

It can be seen that hydroxyapatite improves high C-rate lifespan characteristics of the lithium secondary battery.

It can be seen therefrom that the positive electrode material for lithium secondary batteries according to embodiments of the present invention has excellent high-rate lifespan characteristics when the weight of the additive is 1 to 3 wt % based on 100 wt % of the total positive electrode material.

TABLE 5

| | Capacity Retention |
|---|---|
| BARE 0% (Comparative Example 1) | 89.9% |
| HAP 1% (Example 1) | 90.4% |
| HAP 3% (Example 2) | 93.3% |

Table 5 shows capacity retention of each of the batteries according to the examples and the comparative example after 100 charge and discharge cycles.

The capacity retention was calculated using Mathematical Expression 4 below.

$$Capacity retention = [ Discharge capacity at 100 th cycle / \\ discharge capacity at first cycle ] \times 100 ( \% ) \qquad Mathematical Expression 4$$

That is, in the lithium secondary battery according to the embodiments of the present invention, hydroxyapatite located on the surface of the positive electrode active material removes hydrofluoric acid formed by electrolyte side reaction, and formation of the SEI on the surface of the electrode is prevented, thereby achieving high electrical conductivity and high lifespan characteristics. In addition, even though the weight of the positive electrode active material is reduced due to the addition of hydroxyapatite, the capacity of the lithium secondary battery is hardly or slightly reduced. Furthermore, hydroxyapatite is chemically and structurally stable and has excellent thermal stability, thereby achieving high electrical conductivity and high lifespan characteristics even at high temperature and high C-rate.

As is apparent from the above description, in a positive electrode material for lithium secondary batteries according to embodiments of the present invention and a method of manufacturing the same, hydroxyapatite located at the surface of a positive electrode active material removes hydrofluoric acid (HF), which causes low electrical conductivity and short lifespan of a lithium secondary battery, thereby achieving high electrical conductivity and high lifespan characteristics of the lithium secondary battery.

The effects of embodiments of the present invention are not limited to those mentioned above, and other unmentioned effects will be clearly understood by an ordinary skilled person from the above description.

The above detailed description should not be construed as being limitative in all terms, but should be considered as being illustrative. The scope of the present invention should be determined by reasonable analysis of the accompanying claims, and all changes within the equivalent range of the present invention are included in the scope of the present invention.

What is claimed is:

1. A positive electrode material for lithium secondary batteries, the positive electrode material comprising:
a positive electrode active material comprising lithium; and
an additive disposed at a surface of the positive electrode active material, wherein the additive comprises hydroxyapatite represented by
Caₐ(PO₄)_{b}(OH)
where (1.5≤b/a≤1.67).

2. The positive electrode material according to claim 1, wherein the positive electrode active material comprises a material represented by
Li(MₓFe₁₋ₓ)PO₄(0.1≤x≤0.9),
in which M is at least one element selected from a transition metal group comprising manganese (Mn).

3. The positive electrode material according to claim 1, wherein a content of the additive is 1 to 3 wt % based on 100 wt % of a total of the positive electrode material.

4. The positive electrode material according to claim 1, wherein the hydroxyapatite has a peak at about 32 to 33 degrees in an analysis using an X-ray diffraction angle (2θ) using a Cu Kα ray.

5. The positive electrode material according to claim 1, wherein the additive is disposed on the surface of the positive electrode active material to define a layered structure and is disposed in an island shape.

6. The positive electrode material according to claim 1, wherein the positive electrode active material and the hydroxyapatite are milled at 100 to 300 rpm in a powder state such that hydroxyapatite is disposed at the surface of the positive electrode active material.

7. The positive electrode material according to claim 1, wherein the positive electrode active material and the hydroxyapatite are milled for 20 to 40 minutes in a powder state such that hydroxyapatite is disposed at the surface of the positive electrode active material.

8. The positive electrode material according to claim 1, wherein the additive is a particle having a particle size of 3 μm or less and greater than 0 μm.

9. A method of manufacturing a positive electrode material for lithium secondary batteries, the method comprising:
preparing a positive electrode active material; and
disposing an additive comprising hydroxyapatite represented by
Caₐ(PO₄)_{b}(OH)
where (1.5≤b/a≤1.67) at a surface of the positive electrode active material.

10. The method according to claim 9, wherein the positive electrode active material comprises a material represented by
Li(MₓFe₁₋ₓ)PO₄(0.1≤x≤0.9),
in which M is at least one element selected from a transition metal group comprising manganese (Mn).

11. The method according to claim 9, wherein a content of the additive is 1 to 3 wt % based on 100 wt % of a total of the positive electrode material.

12. The method according to claim 9, wherein the positive electrode active material and the hydroxyapatite are physically mixed with each other in a powder state.

13. The method according to claim 12, wherein the positive electrode active material and the hydroxyapatite are physically mixed with each other by milling at 100 to 300 rpm.

14. The method according to claim 12, wherein the positive electrode active material and the hydroxyapatite are physically mixed with each other by milling for 20 to 40 minutes.

15. The method according to claim 9, wherein the additive is a particle having a particle size of 3 μm or less and greater than 0 μm.

16. A lithium secondary battery comprising:
a positive electrode comprising:
a positive electrode active material comprising lithium; and
an additive disposed at a surface of the positive electrode active material, wherein the additive comprises hydroxyapatite represented by
Caₐ(PO₄)_{b}(OH)
where (1.5≤b/a≤1.67);
a negative electrode; and
an electrolyte.

17. The lithium secondary battery according to claim 16, further comprising a separator disposed between the positive electrode and the negative electrode.

18. The lithium secondary battery according to claim 16, wherein the positive electrode active material comprises a material represented by
Li(MₓFe₁₋ₓ)PO₄(0.1≤x≤0.9),
in which M is at least one element selected from a transition metal group comprising manganese (Mn).

19. The lithium secondary battery according to claim 16, wherein a content of the additive is 1 to 3 wt % based on 100 wt % of a total of a positive electrode material comprising the positive electrode active material, and wherein the additive is a particle having a particle size of 3 μm or less and greater than 0 μm.

20. The lithium secondary battery according to claim 16, wherein the hydroxyapatite has a peak at about 32 to 33 degrees in an analysis using an X-ray diffraction angle (2θ) using a Cu Kα ray.
